(19) United States
(12) Patent Application Publication
(10) Pub. No.: US 2017/0359442 A1
(43) Pub. Date: Dec. 14, 2017

(54) Distribution of Location-Based Augmented Reality Captures

(71) Applicants: iTagged Inc., Beverly, MA (US); iTagged Mobile Limited, Dublin (IE)

(72) Inventor: Keith Jordan, Dublin (IE)

(21) Appl. No.: 15/531,165

(22) PCT Filed: Nov. 24, 2015
(86) PCT No.: PCT/US2015/062401

§ 371 Date: May 26, 2017

Related U.S. Application Data
(60) Provisional application No. 62/084,684, filed on Nov. 26, 2014.

(51) Int. Cl. H04L 29/06; G06T 19/00; H04L 29/08

(52) U.S. Cl. CPC H04L 67/38; H04L 67/18; G06T 19/006

(57) ABSTRACT

Featured is a method for distributing location-based augmented reality captures. The method can include creating an augmented reality capture on a first device, packaging the augmented reality capture, and transmitting the augmented reality capture to a second device via a communications protocol. The first device can be, for example, a smartphone or a laptop. The second device can be a smartphone, a laptop, or a remote server. The remote server can function as a cloud-based web service. Also featured is a device for distributing location-based augmented reality captures embodying such methods for distributing.

This application claims the benefit of U.S. Provisional Application Ser. No. 62/084,684 filed Nov. 26, 2014, the teachings of which are incorporated herein by reference in its entirety.

### BACKGROUND OF INVENTION

Augmented reality (AR) refers to the live direct or indirect view of a physical, real-world environment. The elements of the real-world environment can be augmented or supplemented with computer-generated sensory inputs such as sound, video, graphics, or GPS data. Augmented reality technology can function by enhancing a user's current perception of reality.

Methods of capturing visual media can require a user to capture a real world experience by specifying the format of visual media, e.g., a photograph or a video, and displaying the visual media in the specified format to the user. The visual media can then be stored on the device.

### SUMMARY OF INVENTION

The disclosed subject matter includes a method for distributing location-based augmented reality captures. The method can include creating an augmented reality capture on a first device, packaging the augmented reality capture, and transmitting the augmented reality capture to a second device via a communications protocol. The first device can be, for example, a smartphone or a laptop. The second device can be a smartphone, a laptop, or a remote server. The remote server can function as a cloud-based web service.

In accordance with embodiments of the disclosed subject matter, the augmented reality capture can include visual media data and an information layer. The information layer can include location data and other augmented reality (AR) data. Other AR data can include directions, audio files, user interface elements, text, telephone numbers, catalog data, video, or information from local databases, network databases, or websites.

Creating an augmented reality capture can include creating a new object and creating an augmented reality capture associated with the new object. In accordance with another embodiment of the disclosed subject matter, creating an augmented reality capture can include obtaining a previously-created object including one or more pre-existing augmented reality captures, creating a new augmented reality capture, and adding the new augmented reality capture to the object.

The augmented reality capture can be transmitted using any communications protocol presently known or hereafter developed. For purposes of explanation and not limitation, the communications protocol can be GSM, GPRS, EDGE, 802.x communication sub systems (e.g., 802.11), CDMA, Bluetooth, TCP/IP protocols, UDP protocols, or USB. The augmented reality capture can be transmitted via a wired connection or via wireless communication. The augmented reality capture can be transmitted to a remote server. The remote server can then transmit the augmented reality capture to another user device. In accordance with an exemplary embodiment of the disclosed subject matter, the augmented reality capture can be synched throughout the system. For example, new augmented reality captures can be added to maps and augmented reality views in the appropriate location. Updated augmented reality captures (i.e., new augmented reality captures being added to a pre-existing object) can also be sent to users that have requested updates on new content added to the existing objects.

According to other aspects/embodiments, the present invention features a device for distributing location-based augmented reality captures that includes a digital processing device; and a software program including one or more of instruction, criteria and code segments for carrying out a method for distributing location-based augmented reality captures as described herein.

In more particular embodiments such a method includes the steps of creating an augmented reality capture on a first device; packaging the augmented reality capture; and transmitting the augmented reality capture to a second device via a communications protocol.

Other aspects and embodiments of the invention are discussed below.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1 is a block diagram view of device according to an embodiment of the present invention.

FIG. 2 illustrates an embodiment of a method for distributing location based augmented reality captures.

FIG. 3 illustrates an embodiment of a method for location-based augmented reality captures.

### DESCRIPTION OF PREFERRED EMBODIMENT

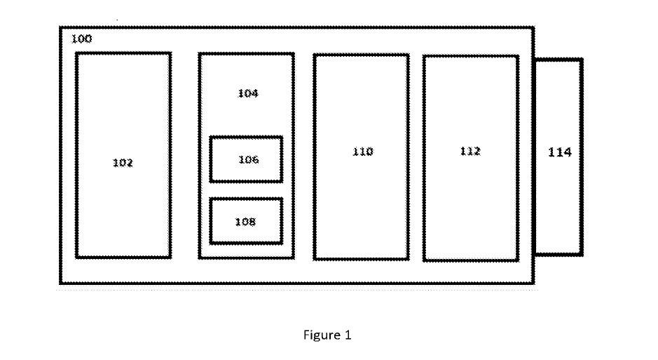

In accordance with one aspect, the disclosed subject matter includes a device for distribution of location-based augmented reality captures. FIG. 1 shows a block diagram of a device 100 in accordance with an exemplary embodiment of the disclosed subject matter. The device 100 can be, for example, a mobile device such as a smartphone or a tablet. In accordance with another embodiment of the disclosed subject matter, the device 100 can be a laptop computer. The device includes one or more processors, each of which can include one more electronic circuits including, for example, computer processor units (CPUs), graphics processor units (GPUs), integrated circuits, and semiconductor devices such as transistors.

Device 100 can include one or more sensors 102. The one or more sensors can include a digital image sensor such as a semiconductor charge-coupled device or an active pixel sensor in, e.g., complementary metal-oxide-semiconductor (CMOS) or N-type metal-oxide-semiconductor (NMOS) technologies. However, other sensors for capturing images or other visual media (e.g., images or video) can also be used in accordance with the disclosed subject matter.

Device 100 can also include a user interface 104. The user interface 104 can include, for example, a display 106 and a user input device 108. The user input device 108 an be, for example, a keyboard. In accordance with certain embodiments of the disclosed subject matter, device 100 can include a touchscreen which, together with any associated software, comprises both the display 106 and the user input device 108. The user input device 108 can sense haptic contact from the user, e.g., via a keyboard or a touchscreen. In accordance with other embodiments of the disclosed subject matter, the user input device 108 may sense audio, e.g., voice commands.

Device 100 can further include one or more onboard sensors 110. The onboard sensors 110 can include a location sensor. The location sensor may use global positioning system (GPS) technology to determine the location of the device. Other known methods for determining the location of the device 100 can also be used. The onboard sensors 110 can also include other sensors such as, for example, a temperature sensor, an accelerometer, and/or a gyroscope. The onboard sensors 110 can also include an audio sensor.

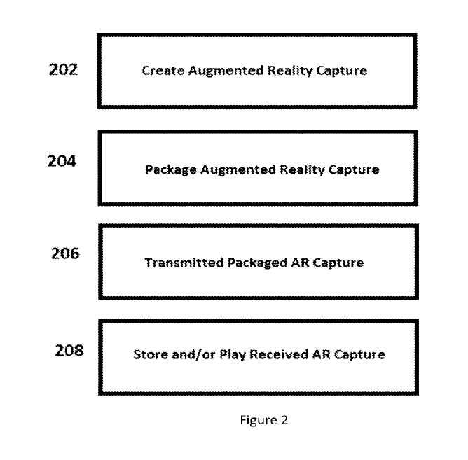

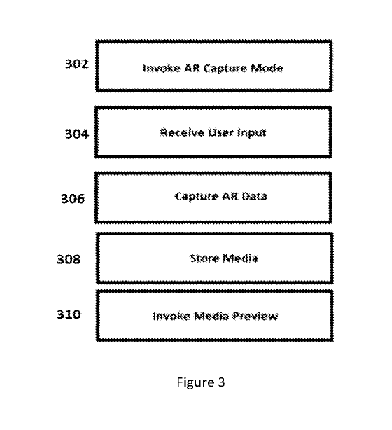

The device can further include a non-transient computer readable medium 112. The computer readable medium 112 can include, for example, Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium. The computer readable medium 112 can store, among other things, executable instructions which, when executed, cause the one or more processors to perform the steps described in, for example, FIGS. 2 and 3.

The device can further include a transceiver 114. The transceiver 114 can provide a communications link between the device 100 and other devices. The transceiver 114 can be a wired connection such as a USB port, or a wireless connection such as an antenna. The device 100 can communicate via the transceiver 114 using any communication protocol. For example, the device 100 can communicate using GSM, GPRS, EDGE, 802.x communication sub systems (e.g., 802.11), CDMA, Bluetooth, TCP/IP protocols, UDP protocols, or other known protocols.

In accordance with embodiments of the disclosed subject matter, transceiver 114 can further operate to gather additional data from remote sources. For example, transceiver 114 can communicate with a cloud-based or server-based system to collect data from remote sensors. The data collected from the remote systems can be based on the location of the device. Transceiver 114 can transmit location data to the cloud-based or server-based system, and data from remote sensors corresponding to the location data can be returned to the transceiver 114.

In accordance with another embodiment of the disclosed subject matter, transceiver 114 can communicate with a third party service to receive information. The device 100 can use an Application Programming Interface (API) for communication with the third party service through the transceiver 114. The device 100 can provide location data to the third party service via the transceiver 114. The third party service can provide, for example, directions, telephone numbers, or other information to the device 100 based on the location data.

In accordance with another aspect, the disclosed subject matter can provide a method for distributing location-based augmented reality captures. An exemplary embodiment of a method for distributing location-based augmented reality captures is illustrated in FIG. 2. Device 100 can record augmented reality (AR) data at 202.

FIG. 3 illustrates a method for location-based augmented reality capture in accordance with an exemplary embodiment of the disclosed subject matter. Device 100 can invoke augmented reality (AR) capture mode at 302. In accordance with an exemplary embodiment of the disclosed subject matter, invocation of the AR capture mode can include providing instructions to turn on the onboard sensors 110 and the transceiver 114 for reception of AR data. For example, invocation of AR capture mode can include turning on a digital imaging sensor, a location sensor and at least one other onboard sensor such as, for example, a temperature sensor, an accelerometer, and/or a gyroscope. However, in accordance with some embodiments of the disclosed subject matter, certain sensors (e.g., the digital imaging and/or location sensors) can be initialized prior to invocation of the AR capture mode.

In accordance with embodiments of the disclosed subject matter, invocation of the AR capture mode can include turning on a plurality of other onboard sensors. Invocation of AR capture mode can initialize receipt of data through the relevant sensors, but does not require recording of the received data.

Invocation of AR capture mode can further include requesting data from remote devices. For example, invocation of AR capture mode can include transmitting a request for data from one or more remote sensors via transceiver 114 and receiving data from the one or more remote sensors. The request can include location data and the device 100 can receive data from the one or more remote sensors based on the location data. For example, a device 100 can receive data from remote sensors located at or around the geographic location identified in the location data. Data can be received once in response to each request, or can be received as a data stream that is periodically updated until AR mode is canceled.

In accordance with another embodiment of the disclosed subject matter, invocation of AR capture mode can include communicating with a third party service using, for example, an API. The device 100 can provide location data to the third party service via the API, and the third party service can return information related to the geographic location corresponding to the location data to the device 100. Data can be received once in response to each communication using the API, or can be received as a data stream that is periodically updated until AR mode is canceled.

In accordance with one embodiment of the disclosed subject matter, AR capture mode can be invoked by creating a new object. For example, a user can create a new tag on a map corresponding to the user's location. In another example, the user can create a new tag or other object in an augmented reality view. AR mode can be automatically invoked upon creation of the new tag. The user can also provide a tag name or other data (e.g., a text comment for description of the tag).

In accordance with another embodiment of the disclosed subject matter, AR mode can be invoked by accessing a previously-created object. For example, a user can access a previously-created tag on a map corresponding to or near a user's location. In another example, a user can access a tag or other object left by another user in an augmented reality view.

The device can then receive user input at 304. The user input can be, for example, haptic input via a touchscreen, a keyboard, or another touch sensor. For example, the device can receive persistent haptic contact from the user to indicate that the user desires to record relevant information for the entire time during which the haptic contact continues. In accordance with other embodiments of the disclosed subject matter, the device can receive user input in other ways, e.g., via voice commands. User input can be received via a user interface 104 as described above.

In response to the user input, the device can capture augmented reality (AR) data at 306. Augmented reality data can include visual media received from digital image sensors. The media can be, for example, a video or a photograph. Augmented reality data can also include location data such as global positioning system (GPS) data. Data from all other onboard sensors that were primed by invocation of AR capture mode can also be captured. Such data can include, for example, a time stamp, temperature information, device speed, device orientation, audio files, and the like. The AR data can also include other information available on the device, e.g., information input by the user and/or information stored on local databases. In accordance with embodiments of the disclosed subject matter, the device can also capture information provided from remote systems via transceiver 114. Such information can include data from remote sensors, directions, audio files, user interface elements, text, telephone numbers, catalog data, video, and information from network databases, or websites. The device can also capture information provided from third party services, e.g., using APIs.

The AR data can be recorded for a time period defined by the user input. For example, in accordance with an exemplary embodiment of the disclosed subject matter, AR data can be recorded from the time when user input (e.g., haptic contact) begins until the time when user input ends. In such a situation, AR data can be captured when the user input is first received and additional measurements can be captured as they are received from onboard sensors 110 and/or transceiver 114 during the defined time period.

The device can store AR data at 308. The AR data can be stored locally on a storage device within device 100. The storage device can be, for example, Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium. The AR data can be stored on the same storage device that stores the instructions which cause the processor to perform the method.

In accordance with another embodiment, the AR data can be stored on a remote device. For example, the AR data can be transmitted from the device via a wireless transmitter to a remote database. In accordance with another embodiment of the disclosed subject matter, the AR data can be transmitted to the remote database using a wired connection. For example, the AR data can be communicated via a USB cable coupled to a USB port of the device. The remote database can operate as a cloud-based web service. Storage on a remote database, can alternatively follow step 210, can allow other users to access the AR capture. For example, when another device is operating in augmented reality view mode, an object representing one or more stored AR captures can appear on the display. In response to the user selecting the object, the AR capture can be made available to the user. Where more than one AR capture is associated with a particular tag or other object, a timeline including each such AR capture can be displayed to the user upon selection of the object. The timeline can permit the user to view changes over time (e.g., for the construction of a building or the changing of the seasons) or the sequence of an event (e.g., a wedding with AR captures in chronological order).

The device can then invoke a media preview at 310. The device can playback the AR data. In accordance with certain embodiments of the disclosed subject matter, the AR data can be played back immediately following the termination of the recording period. The playback can include, for example, playback of a combined information layer, location data, and sensor data. The device can provide the user an opportunity to supplement the captured AR data. For example, the device can allow the user to add text or additional media files to the AR data. In accordance with another embodiment, the device can allow the user to choose whether the AR data can be made available to others and/or how long the AR data will be available to others. After the user has added (or declined to add) additional information, the AR capture can be stored locally and/or remotely as previously described.

In accordance with one embodiment of the disclosed subject matter, when a user is adding new information to a previously-created object, the new AR capture can be stored with the pre-existing data (which can include one or more previous AR captures) associated with that object.

Device 100 can package the augmented reality capture at 204. The augmented reality capture can include the visual media and an information layer. The information layer can include location data and other AR data. The augmented reality capture can be packaged according to the desired transmission protocol.

Device 100 can then transmit the packaged augmented reality capture at 206 using transceiver 114. The augmented reality capture can be transmitted using any communication protocol such as, for example, GSM, GPRS, EDGE, 802.x communication sub systems (e.g., 802.11), CDMA, Bluetooth, TCP/IP protocols, UDP protocols, or USB.

The augmented capture can be transmitted to a remote database. If the AR capture relates to a new object (e.g., a new tag) created by the user, the new tag and the associated AR capture is stored at the remote database. If the AR capture relates to a previously-created object, the system synchs the remote database and the user device such that the new AR capture is added to the object stored on the remote database. In accordance with an embodiment of the disclosed subject matter, users can request receipt of any updates to a particular object (e.g., by “following” a particular tag). In such a situation, the remote database can then update the tag throughout the system by distributing the new AR capture to the devices of the “following” users. Where a new AR capture is added to a pre-existing object, the entire object can be transmitted. Alternatively, only the new AR capture and information about the tag to which the new information should be added can be transmitted.

In accordance with another embodiment of the disclosed subject matter, the augmented reality capture can be transmitted to another user device via peer-to-peer technology. For example, the augmented reality capture can be transmitted to another user device in the same geographic location.

The receiving device can store and/or play back the received augmented reality capture. For example, the receiving device can play back the received augmented reality capture when it is within a certain distance of the location identified in the location data of the received augmented reality capture. In another embodiment, the receiving device can play back the received augmented reality capture at any time and from any location.

The receiving device can access the AR capture in a variety of ways. For example, the receiving device can use a map to identify a particular geographic area to search. All objects in the selected geographic area, or a brief summary of each object, can be delivered to the receiving device. The geographic location could be based on location data associated with the user device, e.g., all objects within a mile of the user device can be delivered to the receiving device. In accordance with another embodiment of the disclosed subject matter, the geographic location can be a user-selected geographic location. For example, the device can allow a user to drop and pin and search for all objects within a certain distance of the pin, or the device can allow a user to create a custom geographic area (e.g., using a touchscreen) for searching.

In accordance with another embodiment of the disclosed subject matter, a user can select objects shown in an augmented reality view. In other embodiments, a user can perform a keyword search on tags and other text. The search can return all objects associated with the keyword as well as all objects that depend from those objects. For example, a tag “New York” may have a number of AR captures associated therewith. The tag “New York” may also have dependent tags “Central Park,” “Empire State Building,” and “Statue of Liberty,” each of which would have AR captures associated therewith. A keyword search for New York would cover all of these tags and associated AR captures. However, a keyword search for Empire State Building, on the other hand, would cover only the “Empire State Building” tag and AR captures associated therewith. A keyword search for “Avenue Q,” however, may only cover a single AR capture within the Empire State Building where a user added text reading: “Visiting the Empire State Building after seeing Avenue Q.” Thus, keyword searches can cover metadata associated with the stored AR captures.

Computer software includes operating systems and user programs such as that to perform the actions or methodology of the present invention as well as user data that can be stored in a computer software storage medium, such as a storage medium within the device, the memory, and/or an external storage for execution on the computer/server. Executable versions of computer software, such as browser, operating system, and other operating software can be read from a non-volatile storage medium such as a storage device within the device, an external storage, and non-volatile memory and loaded for execution directly into the volatile memory, executed directly out of the non-volatile memory, or storage medium within the device prior to loading into the volatile memory for execution on the computer processor.

The flow charts and/or description herein illustrate the structure of the logic(s) of the present invention as embodied in a computer program software for execution on a computer, digital processor or microprocessor. Those skilled in the art will appreciate that the flow charts and the description herein illustrate the structures of the computer program code elements, including logic circuits on an integrated circuit that function according to the present invention. As such, the present invention is practiced in its essential embodiment(s) by a machine component that renders the program code elements in a form that instructs a digital processing apparatus (e.g., computer) to perform a sequence of function step(s) corresponding to those shown in the flow diagrams and/or as described herein.

The presently disclosed subject matter is not to be limited in scope by the specific embodiments herein. Indeed, various modifications of the disclosed subject matter in addition to those described herein will become apparent to those skilled in the art from the foregoing description and the accompanying figures. Further, although a preferred embodiment of the invention has been described using specific terms, such description is for illustrative purposes only, and it is to be understood that changes and variations may be made without departing from the spirit or scope of the following claims.

What is claimed is:

1. A method for distributing location-based augmented reality captures, said method comprising the steps of:
creating an augmented reality capture on a first device;
packaging the augmented reality capture; and
transmitting the augmented reality capture to a second device via a communications protocol.

2. The method of claim 1, wherein the first device is one of a smartphone or a laptop; and wherein the second device is one of a smartphone, a laptop, or a remote server.

3. The method of claim 1, wherein the augmented reality capture includes one of visual media data and an information layer.

4. The method of claim 1, wherein the information layer includes location data and other augmented reality (AR) data.

5. The method of claim 4, wherein other AR data includes at least one of directions, audio files, user interface elements, text, telephone numbers, catalog data, video, or information from local databases, network databases, or websites.

6. The method of claim 1, wherein said creating an augmented reality capture further includes creating a new object and creating an augmented reality capture associated with the new object.

7. The method of claim 1, wherein said creating an augmented reality capture further includes obtaining a previously-created object including one or more pre-existing augmented reality captures, creating a new augmented reality capture, and adding the new augmented reality capture to the object.

8. The method of claim 1, wherein the communications protocol includes GSM, GPRS, EDGE, 802.x communication sub systems (e.g., 802.11), CDMA, Bluetooth, TCP/IP protocols, UDP protocols, or USB; and wherein said transmitting includes transmitting the augmented reality capture one of via a wired connection or via wireless communication.

9. The method of claim 1, wherein said transmitting includes transmitting the augmented reality capture to a remote server as the second device and wherein said method further includes the remote server transmitting the augmented reality capture to another user device.

10. The method of claim 1, further comprising adding new augmented reality captures to maps an adding the augmented reality views in the appropriate location.

11. A device for distributing location-based augmented reality captures, comprising:
a digital processing device; and
a software program including one or more of instruction, criteria and code segments for carrying out a method for distributing location-based augmented reality captures, said method comprising the steps of:
creating an augmented reality capture on a first device;
packaging the augmented reality capture; and
transmitting the augmented reality capture to a second device via a communications protocol.
